(19) United States
(12) Patent Application Publication
(10) Pub. No.: US 2015/0187087 A1
(43) Pub. Date: Jul. 2, 2015

(54) ELECTRONIC DEVICE AND METHOD FOR USING THE SAME

(71) Applicant: Samsung Electronics Co., Ltd., Gyeonggi-do (KR)

(72) Inventor: Juntaek LEE, Daegu (KR)

(21) Appl. No.: 14/528,419

(22) Filed: Oct. 30, 2014

(30) Foreign Application Priority Data
Oct. 30, 2013 (KR) 10-2013-0130224

(51) Int. Cl. G06T 7/20; G06K 9/46

(52) U.S. Cl. CPC G06T 7/204; G06T 7/2006; G06K 9/4609; G06T 2207/20076; G06T 2207/20148

(57) ABSTRACT

An electronic device and method for using an electronic device. The method includes extracting feature points from first image data and second image data, respectively, grouping the extracted feature points of the first image data and the second image data, respectively, tracing groupings of extracted feature points of the second image data to corresponding groupings of extracted feature points of the first image data, and calculating displacement information by using the tracings.

### PRIORITY

This application claims priority under 35 U.S.C. §119(a) to a Korean Patent Application filed on Oct. 30, 2013 in the Korean Intellectual Property Office and assigned Serial No. 10-2013-0130224, the entire contents of which are incorporated herein by reference.

### BACKGROUND

1. Field of the Invention

The present invention relates generally to an electronic device and method for providing a user interface, and more particularly, to an electronic device and method of controlling external devices by using displacement information of the electronic device.

2. Description of the Related Art

In order to measure movement of a conventional terminal, the movement of the terminal is measured using various sensors, such as a Global Positioning System (GPS) module and an optical sensor, which are installed in the terminal. Alternatively, a technology for detecting the movement of a terminal uses images, where a marker is placed in front of a camera, and then the marker is traced to thereby detect the movement of the terminal. That is, the distance by which the marker moves in the image is calculated, and the calculated distance is used for detecting the movement of the terminal.

### SUMMARY

The present invention has been made to provide at least the advantages described below.

Accordingly, an aspect of the present invention is to provide an electronic device and a method by which displacement information of the electronic device is accurately detected by tracing fine movement that cannot be detected by sensors or specific feature points in image data. Another aspect of the present invention is to provide an electronic device and method by which external devices can be easily controlled by using the displacement information of the electronic device.

In accordance with an aspect of the present invention, a method of using an electronic device is provided. The method includes extracting feature points from a first image data and a second image data, respectively; grouping the extracted feature points of the first image data and the second image data, respectively; tracing groupings of extracted feature points of the second image data to corresponding groupings of extracted feature points of the first image data; and calculating displacement information by using the tracings.

In accordance with another aspect of the present invention, an electronic device is provided. The electronic device includes an image input unit; a feature point extracting unit configured to extract feature points from a first image data and a second image data received from the image input unit, respectively; a feature point managing unit configured to group the extracted feature points of the first image data and a second image data, respectively; a feature point tracing unit configured to trace feature point groups in the second image data to corresponding feature point groups in the first image data; and a displacement calculating unit configured to calculate displacement information by using the traces.

### BRIEF DESCRIPTION OF THE DRAWINGS

The above and other aspects, features, and advantages of certain embodiments of the present invention will be more apparent from the following detailed description, taken in conjunction with the accompanying drawings, in which:

FIG. 1 is a block diagram illustrating an electronic device according to an embodiment of the present invention;

FIGS. 2 and 3 illustrate extracting feature points according to an embodiment of the present invention;

FIG. 4 illustrates dividing image data into one or more areas according to an embodiment of the present invention;

FIG. 5 illustrates extracting feature points by adjusting a threshold value according to an embodiment of the present invention;

FIG. 6 illustrates extracting feature points by adjusting a threshold value for each area according to an embodiment of the present invention;

FIG. 7 illustrates configuring an order of priority with respect to at least one divided area according to an embodiment of the present invention;

FIG. 8 illustrates grouping feature points per area according to an embodiment of the present invention;

FIG. 9 illustrates tracing feature point groups according to an embodiment of the present invention;

FIG. 10 illustrates calculating displacement information according to an embodiment of the present invention;

FIGS. 11A to 11C illustrate electronic devices according to embodiments of the present invention; and

FIG. 12 is a flowchart of a method of using an electronic device according to an embodiment of the present invention.

### DETAILED DESCRIPTION OF EMBODIMENTS OF THE PRESENT INVENTION

Hereinafter, various embodiments of the present invention are described in detail with reference to the accompanying drawings. It should be noted that the same elements will be designated by the same reference numerals although they are shown in different drawings. Further, a detailed description of a known function and configuration which may make the subject matter of the present invention unclear will be omitted. Hereinafter, it should be noted that only descriptions that facilitate understanding of the embodiments of the present invention are provided. Other descriptions are omitted to avoid obfuscation of the subject matter of the present invention.

An electronic apparatus according to the present invention may be an apparatus having a communication function. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an Moving Picture Experts Group Audio Layer 3 (MP3) player, a mobile medical device, an electronic bracelet, an electronic necklace, an electronic appcessory, a camera, a wearable device, an electronic clock, a wristwatch, home appliances (for example, an air-conditioner, vacuum, an oven, a microwave, a washing machine, an air cleaner, and the like), an artificial intelligence robot, a television (TV), a Digital Video Disk (DVD) player, an audio device, various medical devices (for example, Magnetic Resonance Angiography (MRA), Magnetic Resonance Imaging (MRI), Computed Tomography (CT), a scanning machine, an ultrasonic wave device, or the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present invention is not limited to the aforementioned devices.

In addition, a sensor such as an optical mouse provided in a conventional electronic device may detect the location displacement with the help of a reflecting object that reflects an emitted light or a laser beam. Thus, the above sensor cannot detect the location displacement without the help of a reflecting object that reflects an emitted light or a laser beam. Further, a method of detecting location displacement by using an image may require a specific object to be designated as a marker. That is, according to the prior art, a marker should exist in both images which are consecutive in time for detection of location displacement. Accordingly, when a marker does not exist in a new image, location displacement cannot be detected.

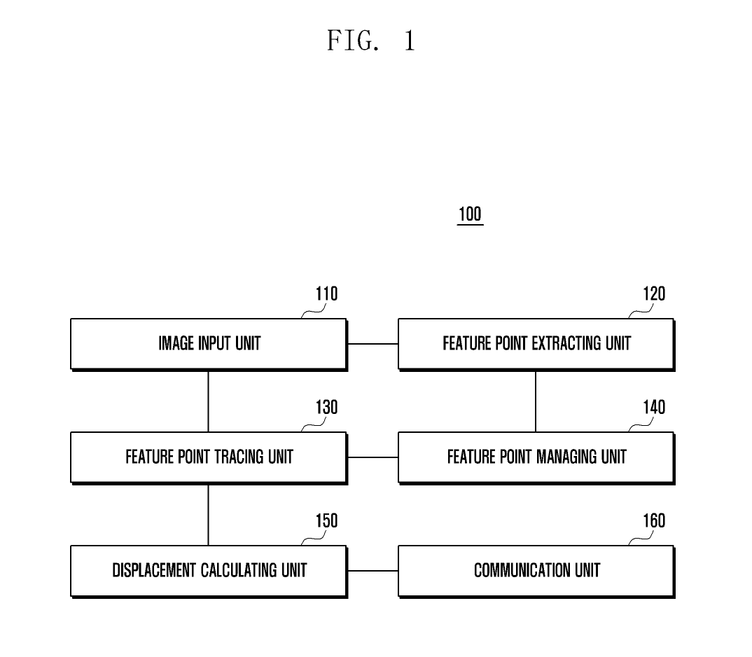

FIG. 1 is a block diagram illustrating an electronic device according to an embodiment of the present invention.

Referring to FIG. 1, an electronic device 100 includes an image input unit 110, a feature point extracting unit 120, a feature point tracing unit 130, a feature point managing unit 140, a displacement calculating unit 150, and a communication unit 160.

The image input unit 110 receives a first image data. In an embodiment of the present invention, the image input unit 110 includes a camera that is able to extract feature points. For example, the camera includes a digital camera, an infrared camera, a high-end digital camera, a hybrid digital camera, a Digital Single Lens Reflex (DSLR) camera, a Digital Single Lens Translucent (DSLT) camera, or the like. Accordingly, the image input unit 110 receives an input of the first image data photographed by the camera. The first image data includes images obtained from the camera.

The feature point extracting unit 120 extracts feature points from the first image data. Hereinafter, for the convenience of explanation, feature points that are extracted from the first image data are referred to as first feature points, and feature points that are extracted from a second image data are referred to as second feature points.

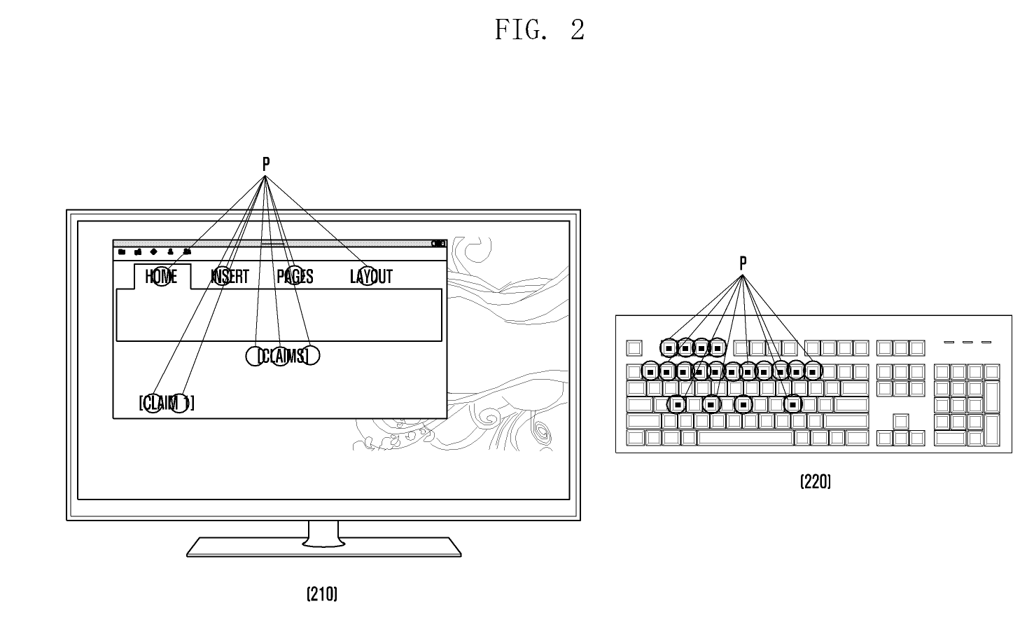

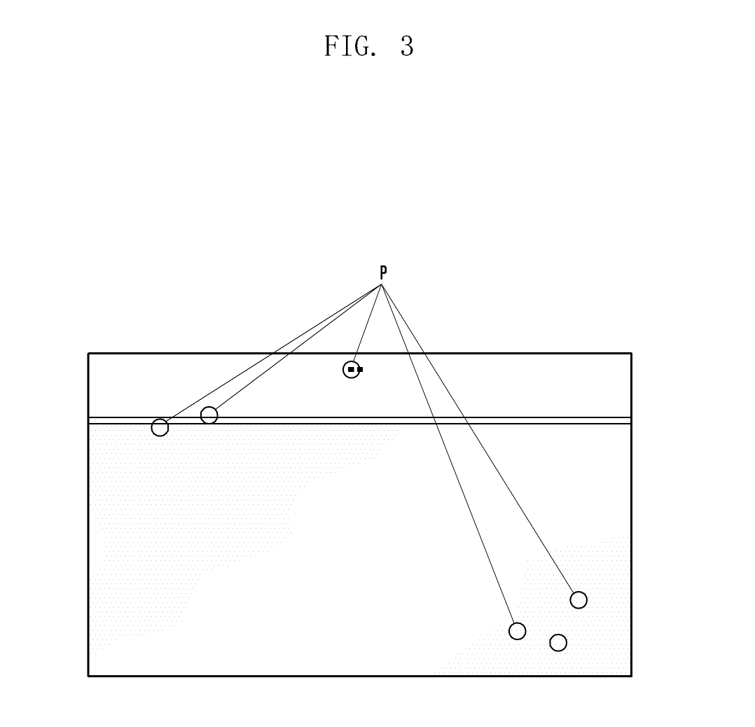

FIGS. 2 and 3 illustrate extracting feature points according to an embodiment of the present invention.

Referring to FIG. 2, the feature point extracting unit 120 extracts the first feature points marked with the reference character P in the first image data by using a feature point extracting algorithm. The feature point extracting unit 120 compares the color in the first image data and extracts the first feature points P with respect to the points that have different colors from the surrounding areas or special portions, such as texts, which are distinct from the surrounding areas as shown in diagram 210 or diagram 220.

In contrast, FIG. 3 shows the bottom of a table. That is, in the first image data of the bottom of the table in which the color remains constant, the first feature points P might not be extracted.

That is, in the case of the first image data of a single color or low illumination reflection, the feature point extracting unit 120 extracts the first feature points from the first image data of a photograph of a live environment.

Feature point extracting algorithms are generally known, so additional explanation thereof is omitted. However, the location or the number of the feature points extracted by the feature point extracting unit 120 may vary according to the feature point extracting algorithm used. In addition, although FIGS. 2 and 3 show that the first feature points are extracted from the first image data, it is obvious that the second feature points may be extracted from the second image data in the same way.

In accordance with an embodiment of the present invention, the feature point extracting unit 120 divides the first image data into one or more areas, and extracts the first feature points on each divided area.

In accordance with an embodiment of the present invention, when the second image data is a blurred image, apply a low-pass filter to the first image data, and extract feature points from the first image data applied with the low-pass filter and the second image data, respectively.

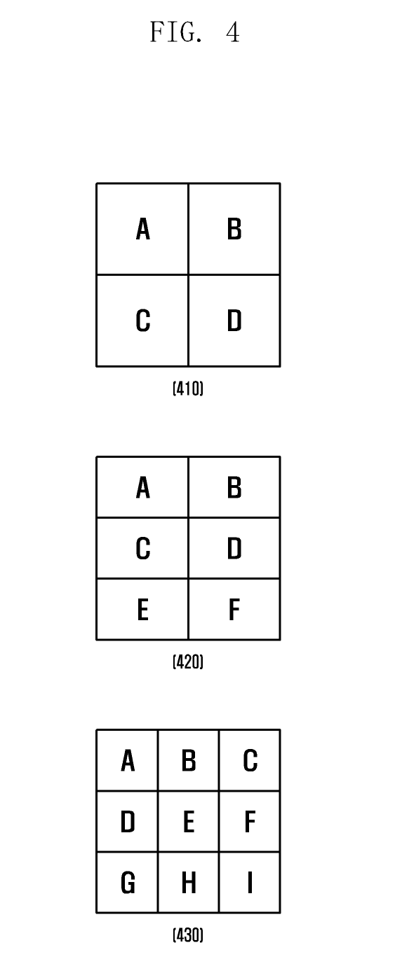

FIG. 4 illustrates dividing image data into one or more areas according to an embodiment of the present invention.

Referring to FIG. 4, the feature point extracting unit 120 divides the first image data into four areas A, B, C and D as shown in diagram 410. Alternatively, the feature point extracting unit 120 may divide the first image data into six areas A, B, C, D, E and F, as shown in diagram 420, or nine areas A, B, C, D, E, F, G, H and I, as shown in diagram 430. Although FIG. 4 shows the areas divided into rectangles, the areas may be divided into various shapes, such as triangles, circles, lenticular forms, polygons having n sides and n vertexes, or the like. In addition, the number of divided areas is user definable.

In accordance with another embodiment of the present invention, the feature point extracting unit 120 adjusts a threshold value of the feature point extracting algorithm on the basis of the number of the extracted first feature points.

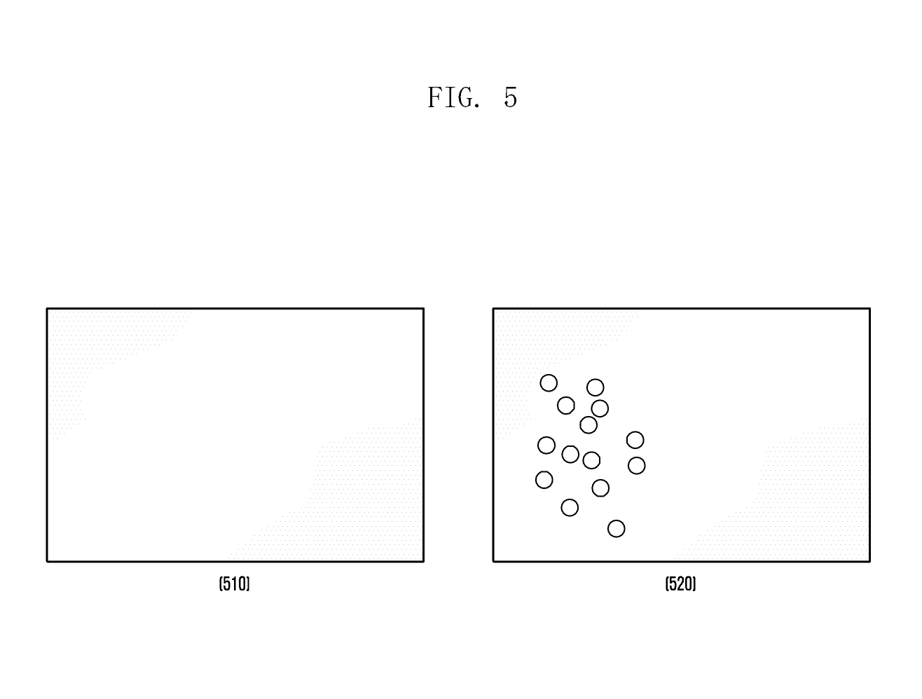

FIG. 5 illustrates extracting feature points by adjusting a threshold value according to an embodiment of the present invention.

Referring to FIG. 5, the feature point extracting unit 120 does not extract first feature points from the first image data as shown in diagram 510. For example, with the threshold value of 50, the feature point extracting unit 120 does not extract first feature points. In this case, the feature point extracting unit 120 gradually reduces the threshold value until at least one first feature point is extracted.

Accordingly, the feature point extracting unit 120 extracts a plurality of first feature points from the first image data by adjusting the threshold value of the feature point extracting algorithm as shown in diagram 520. For example, diagram 520 shows the result of the feature point extracting unit 120 reducing the threshold value to 20, where a plurality of first feature points are extracted.

However, according to the prior art, when an electronic device moves slowly, sensors installed in the electronic device cannot accurately measure the displacement distance. Since the detected sensor value of the electronic device does not exceed a specific threshold value, the detected sensor value cannot be used for the location displacement. Further, since the reduction of the threshold value by the electronic device may cause an unexpected malfunction by which, for example, noise may be misrecognized as a sensor value, it is not recommended to adjust the threshold value to obtain a sensor value for location displacement.

Furthermore, since the first image data may have different colors and portions depending on the areas, the number of the extracted first feature points may vary according to area. Accordingly, the feature point extracting unit 120 of the present invention adjusts the threshold value of the feature point extracting algorithm by the area on the basis of the number of extracted first feature points.

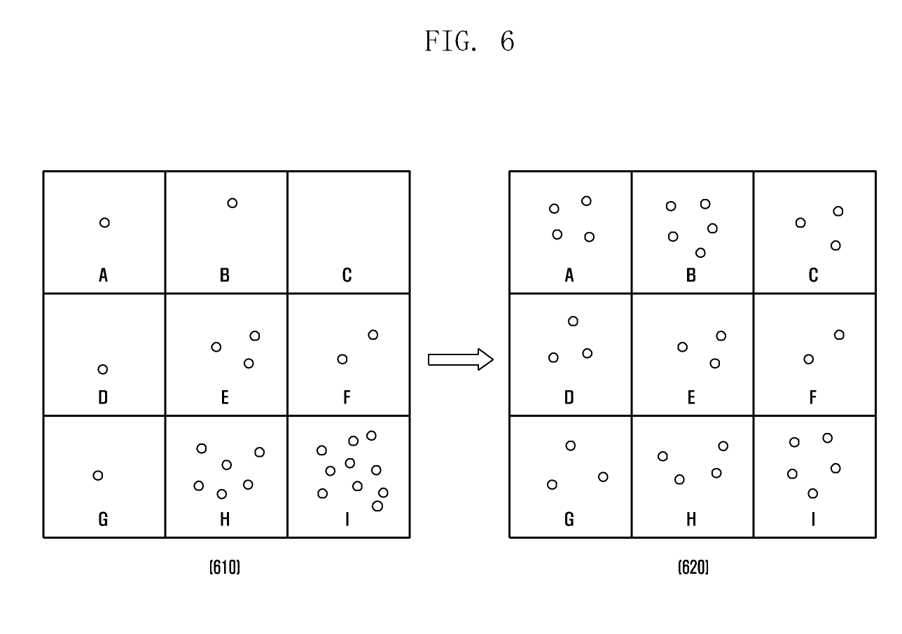

FIG. 6 illustrates extracting feature points by adjusting a threshold value for each area according to an embodiment of the present invention.

Referring to FIG. 6, as shown in diagram 610, the feature point extracting unit 120 divides the first image data into nine areas A to I and extracts first feature points for each of the divided areas. Then, the feature point extracting unit 120 adjusts the threshold value with respect to the areas A, B, C, D, and G, where the number of the extracted first feature points is less than or equal to 1, and extracts the first feature points again as shown in diagram 620. That is, the feature point extracting unit 120 extracts the first feature points again, while gradually reducing the threshold value with respect to the areas A, B, C, D and G.

Alternatively, the feature point extracting unit 120 adjusts the threshold value with respect to the area where the number of extracted first feature points is greater than a predetermined reference value, to thereby extract the first feature points again. For example, the reference value may be 5. The feature point extracting unit 120 extracts the first feature points again, while gradually increasing the threshold value with respect to the areas H and I, where the number of the extracted first feature points is greater than 5. Comparing diagram 610 with diagram 620, the number of feature points in diagram 610 is different from the number of feature points in diagram 620.

According to another embodiment of the present invention, the feature point extracting unit 120 configures the order of priority with respect to at least one of the divided areas and adjusts the threshold value of the feature point extracting algorithm according to the order of priority on each area.

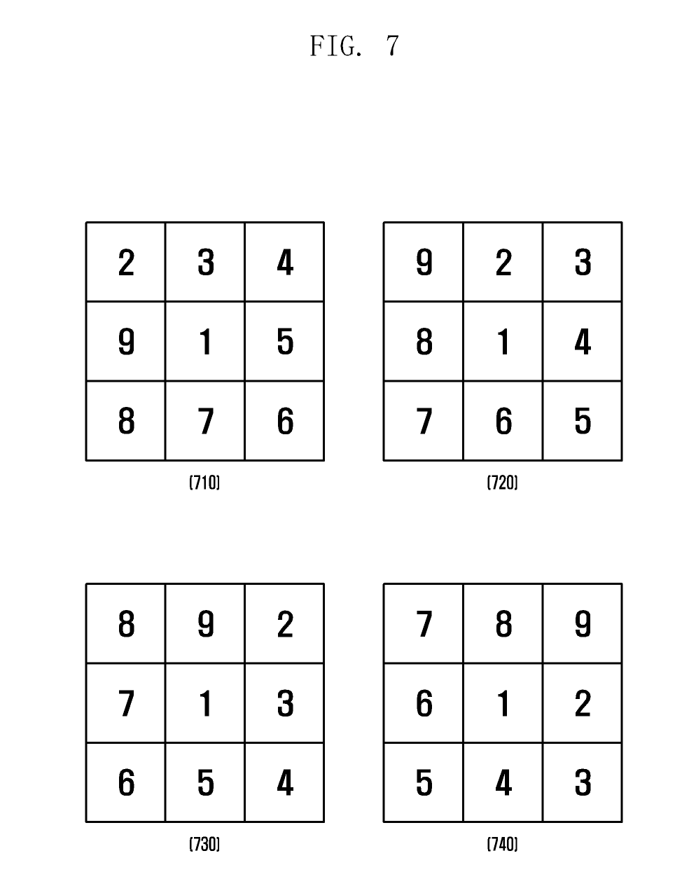

FIG. 7 illustrates configuring the order of priority with respect to at least one of the divided areas according to an embodiment of the present invention.

Referring to FIG. 7, the feature point extracting unit 120 configures the order of priority with respect to at least one of the divided areas. The order of priority is the order of searching for feature points to be traced. For example, the feature point extracting unit 120 extracts the feature points from the middle area that is the first order area of the first image data (i.e., the area identified by the number 1). That is, in the case of the electronic device 100 moving in all directions, it is very likely that the first feature points that were previously extracted from the first order area may be extracted from the second to nine order areas of the second image data that is input next.

For example, the second image data refers to the image data that is input after the first image data in time. The second image data may be the frame just after the first image data in time. Alternatively, there may be a big time difference of frame between the first image data and the second image data. Accordingly, the first feature points extracted from the first image data may or may not be the same as the second feature points extracted from the second image data.

Accordingly, the feature point extracting unit 120 may configure the middle area among the nine divided areas to be the first order area as shown in diagram 710, and configure the remaining eight areas to be the second to the ninth order areas in ascending order as shown in diagrams 720, 730 and 740. That is, the feature point extracting unit 120 may configure the order of priority of the remaining eight areas to be variable except for the first order area. Comparing diagrams 710 to 740 with each other, all the middle areas of diagrams 710 to 740 are the first order area, and the remaining eight areas thereof are slightly different from each other in the order of priority.

The feature point managing unit 140 groups the extracted first feature points. For example, when the illumination or the photographing angle for photographing the second image data is changed, even though the first feature points extracted from the first image data exist in the second image data as well, the feature point extracting unit 120 may not extract the second feature points from the second image data. Accordingly, the feature point managing unit 140 may group the first feature points so that the second feature points that match any one of the first feature point group can be easily traced. That is, it is easier to trace the feature point that matches any one of a plurality of feature points rather than to trace the feature point that matches only one feature point.

In accordance with an embodiment of the present invention, the feature point managing unit 140 groups the extracted first feature points by at least one of the divided areas.

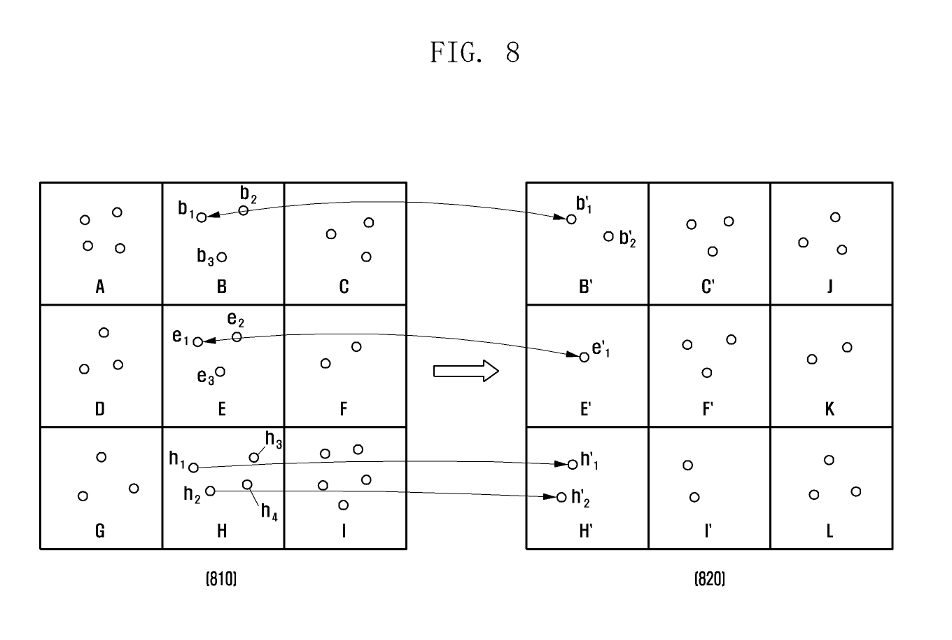

FIG. 8 illustrates grouping feature points by area according to an embodiment of the present invention.

Referring to FIG. 8, the feature point managing unit 140 creates the first feature point groups by grouping the first feature points with respect to each of nine divided areas A to I of the first image data denoted by the reference numeral 810. Afterwards, the feature point managing unit 140 creates the second feature point groups by grouping the second feature points with respect to each of nine divided areas of the second image data denoted by the reference numeral 820, which is input after the first image data.

The feature point tracing unit 130 traces the second feature point groups in the second image data to corresponding first feature point groups. The feature point tracing unit 130 traces the second feature point groups to corresponding first feature point groups, by comparing the first feature point groups with the second feature point groups per area.

For example, the image input unit 110 receives the second image data which has been moved to the right side of the first image data denoted by the reference numeral 810. The second image data is denoted by the reference numeral 820. The feature point extracting unit 120 extracts the first feature points from the first image data 810 and the second feature points from the second image data 820, respectively. The feature point managing unit 140 groups the first feature points of the first image data 810 per area and the second feature points of the second image data 820 per area. The feature point tracing unit 130 matches the area B′ of the second image data 820 with the area B of the first image data 810, and matches the feature point groups with each other that are between areas B and B′. For example, the feature point tracing unit 130 traces the second feature point group b′₁ and b′₂ in area B′, which matches the first feature point group b₁, b₂ and b₃ extracted from area B. In addition, the feature point tracing unit 130 traces the second feature point group e′₁ in area E′, which matches the first feature point group e₁, e₂ and e₃ extracted from area E. In addition, the feature point tracing unit 130 traces the second feature point group h′₁ and h′₂ in area H′, which matches the first feature point group h₁, h₂ and h₃ extracted from the area H.

As described above, with the change of illumination or photographing angle, even though the feature points extracted from the first image data 810 exist in the second image data 820, the feature points might not be extracted. Accordingly, by checking whether the second feature points in the second image data 820 corresponds to at least one of the first feature points in the first feature point groups, the feature point tracing unit 130 traces the second feature points in the second image data 820 that match the first feature points extracted from the first image data 810.

The displacement calculating unit 150 calculates displacement information by using the traced second feature point groups.

In accordance with an embodiment of the present invention, the electronic device 100 further includes an acceleration sensor (not shown) for measuring an acceleration value. The displacement calculating unit 150 calculates the displacement information by reflecting the measured acceleration value.

In accordance with another embodiment of the present invention, the electronic device 100 further includes a gyro-sensor (not shown) for measuring a rotational displacement value. The displacement calculating unit 150 calculates the displacement information by reflecting the measured rotational displacement value

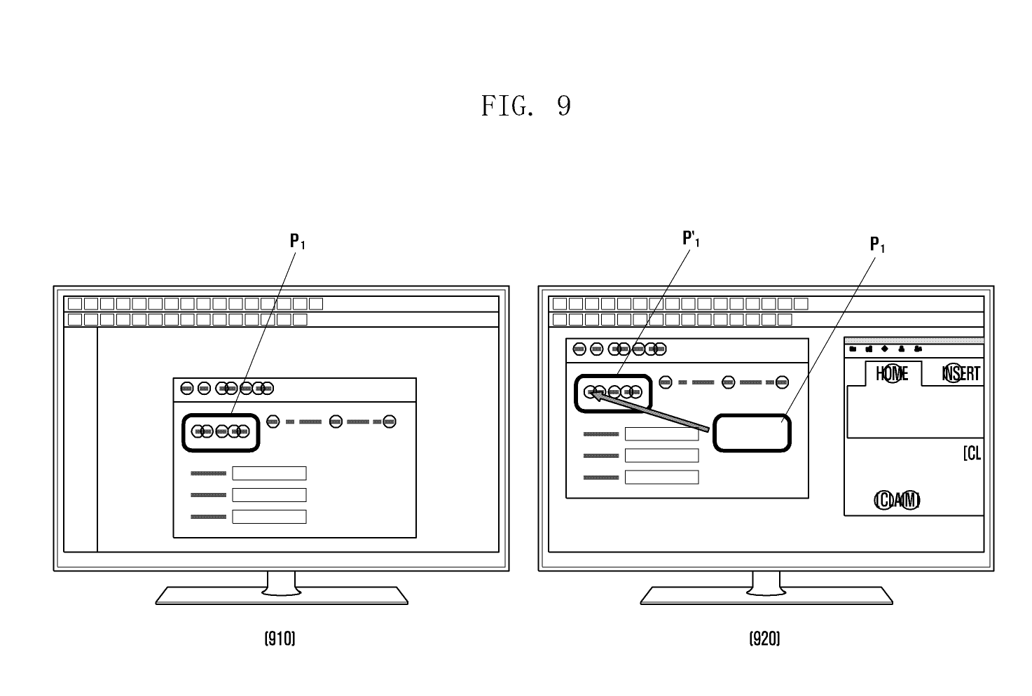

FIG. 9 illustrates tracing feature point groups according to an embodiment of the present invention.

Referring to FIG. 9, as the electronic device 100 moves, the first feature point P₁ extracted from the first image data shown in diagram 910 is traced by the second feature point P′₁ in the second image data shown in diagram 920. The displacement calculating unit 150 calculates the displacement information by using the change of coordinate values between the first feature point P₁ and the second feature point P′₁. FIG. 9 shows the displacement information calculated by using one feature point, but displacement information calculated by using at least one feature point group may be more accurate.

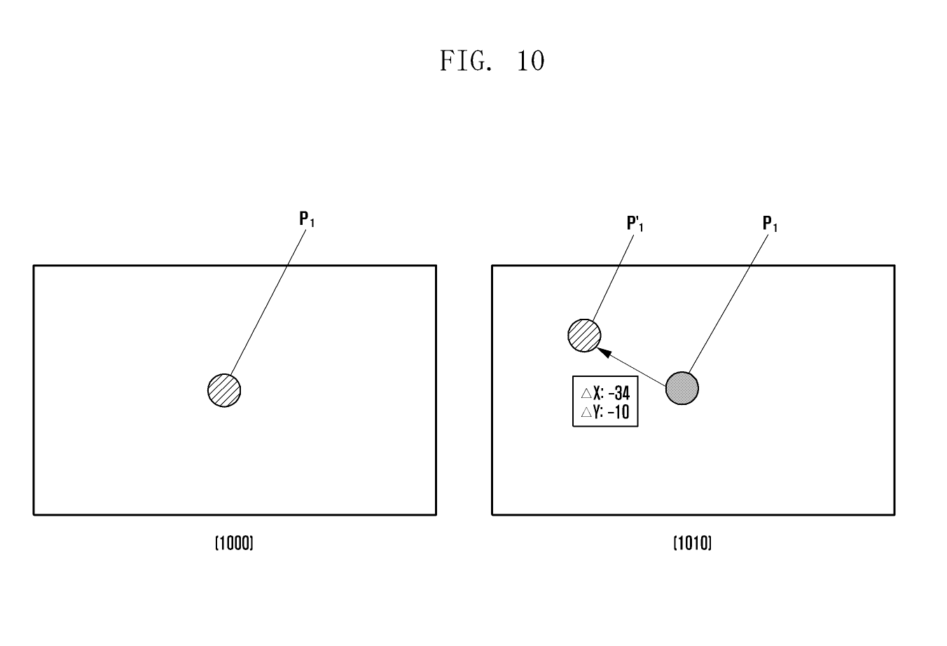

FIG. 10 illustrates calculating displacement information according to an embodiment of the present invention.

Referring to FIG. 10, diagram 1000 shows the first feature point P₁ extracted from the first image data, and diagram 1010 shows the first feature point P′₁ extracted from the second image data. The displacement calculating unit 150 calculates the displacement information of (−34, −10) between the first feature point P₁, which is extracted from the first image data (see diagram 1000), and the second feature point P′₁, which is traced in the second image data (see diagram 1010). (−34, −10) shows that the displacement on the X-axis is −34 and the displacement on the Y-axis is −10. The displacement calculating unit 150 calculates the displacement information by vector values between a coordinate value of the first feature point P₁ and a coordinate value of the second feature point P′₁.

The displacement calculating unit 150 may calculate more accurate displacement information by reflecting an acceleration value measured by an acceleration sensor. In addition, the displacement calculating unit 150 may calculate more accurate displacement information by reflecting a rotational displacement value measured by a gyro-sensor.

The communication unit 160 transmits the calculated displacement information to external devices. The external devices are paired with the electronic device 100, and include all electronic devices that can be controlled by the electronic device 100. According to an embodiment of the present invention, the external device may or may not be the same as the electronic device 100. In an embodiment of the present invention, the communication unit 160 may control the external devices by using the displacement information. The communication unit 160 performs voice communication, video communication or data communication with the external devices through networks. The communication unit 160 may include a radio frequency transmitter for modulating and amplifying the frequency of a signal to be transmitted, and a radio frequency receiver for low-noise-amplifying and demodulating the frequency of a received signal. In addition, the communication unit 160 may include a mobile communication unit (e.g., a 3-Generation mobile communication module, a 3.5-Generation mobile communication module, or a 4-Generation mobile communication module), a Digital Broadcasting Module (e.g., a DMB module) and a short range communication unit {e.g., a Wireless Fidelity (Wi-Fi) module, Bluetooth module, a Near Field Communication (NFC) module, or the like}.

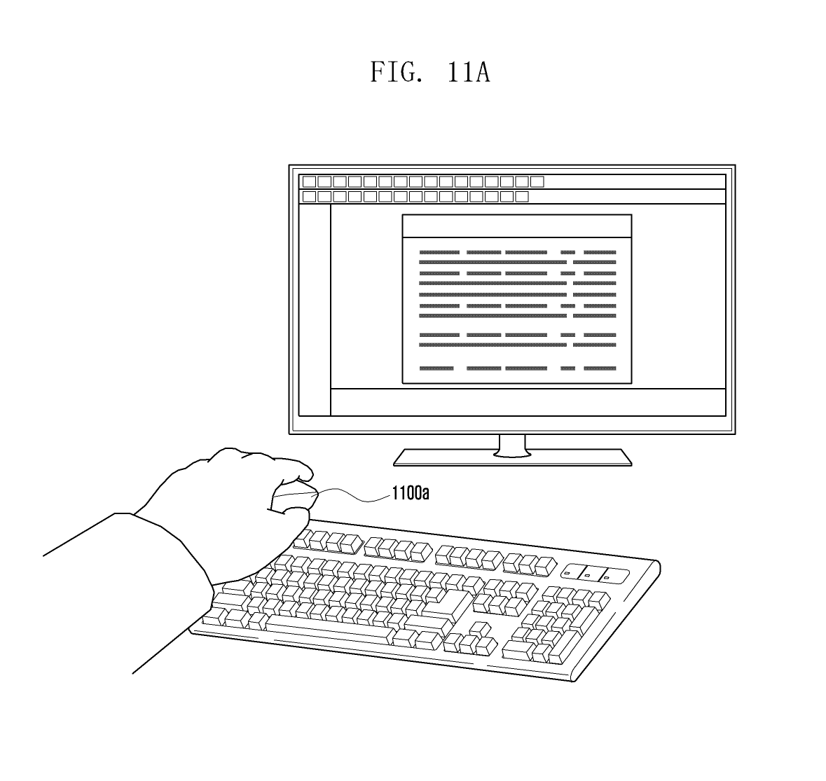

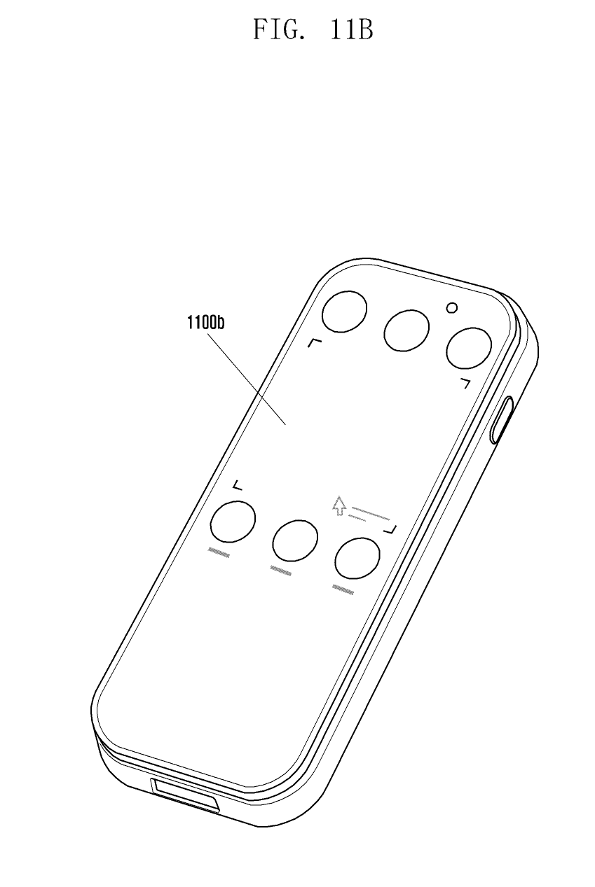

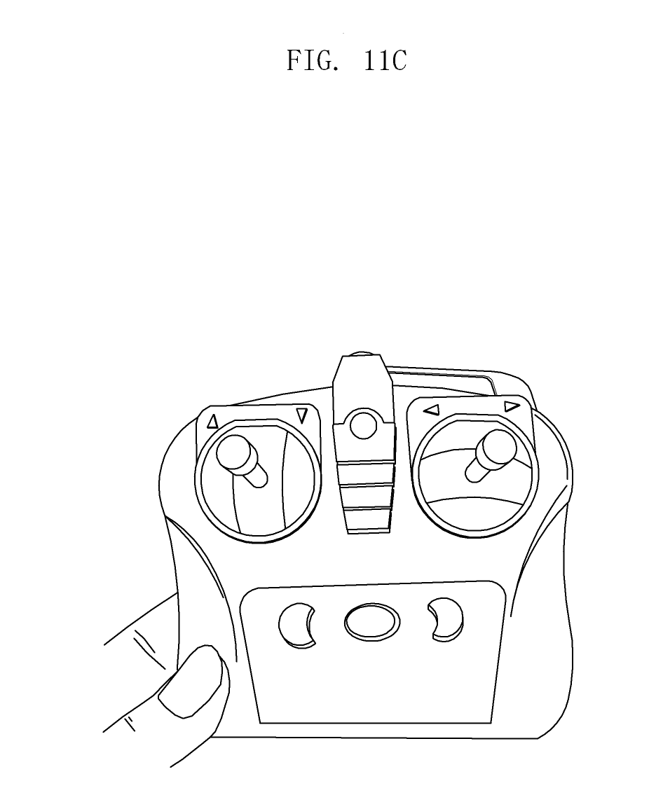

FIGS. 11A to 11C illustrate electronic devices according to an embodiment of the present invention.

Referring to FIG. 11A, the reference numeral 1100a denotes a mouse as the electronic device 100 that is paired with the external device, i.e., a computer to control the same.

Referring to FIG. 11B, the reference numeral 1100b denotes a remote controller as the electronic device 100 that is paired with the external devices, such as TVs, set-top boxes and fans, to control the same.

FIG. 11C shows a controller as the electronic device 100 to control the external devices, such as game players, vehicles, motors, cranes, and the like.

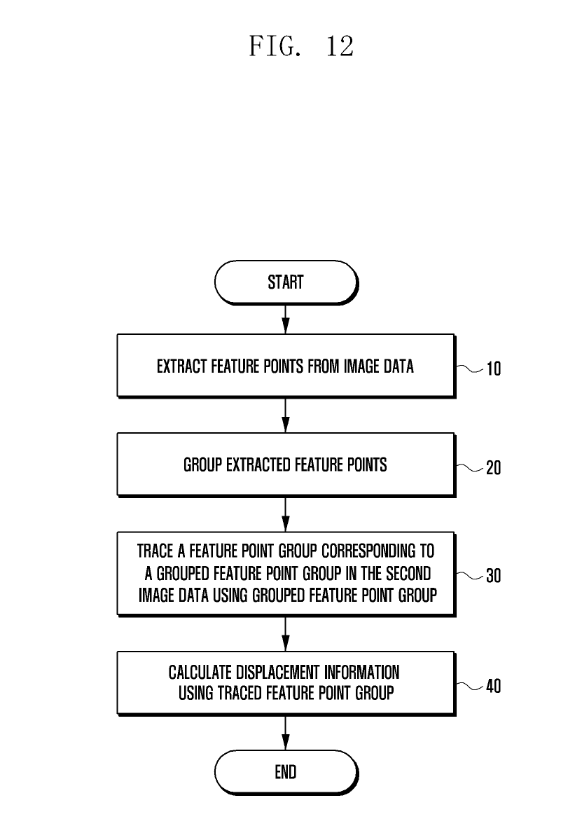

FIG. 12 is a flowchart illustrating a method of using an electronic device 100 according to an embodiment of the present invention.

Referring to FIG. 12, the method of using the electronic device 100 may be executed by the electronic device 100 of FIG. 1.

In step 10, a feature point extracting unit of the electronic device 100 extracts feature points from the first image data. The feature point extracting unit receives the first image data or the second image data from an image input unit of the electronic device 100. The feature point extracting unit extracts the first feature points from the first image data and the second feature points from the second image data, respectively, by using a feature point extracting algorithm. Hereinafter, for the convenience of explanation, feature points, which are extracted from the first image data, are referred to as first feature points, and feature points, which are extracted from the second image data, are referred to as second feature points.

The location or the number of the feature points extracted by the feature point extracting unit may differ according to the feature point extracting algorithm used.

In accordance with an embodiment of the present invention, the feature point extracting unit divides the first image data into one or more areas, and extracts the first feature points on each of the divided areas. Alternatively, the feature point extracting unit adjusts a threshold value of the feature point extracting algorithm on the basis of the number of extracted first feature points. For example, when the feature point extracting unit is unable to extract first feature points in the first image data, the feature point extracting unit gradually reduces the threshold value until at least one first feature points is extracted. Alternatively, the feature point extracting unit configures the order of priority with respect to at least one of the divided areas and adjusts the threshold value of the feature point extracting algorithm according to the order of priority per area.

In step 20, a feature point managing unit of the electronic device 100 groups the extracted feature points. The feature point managing unit creates feature point groups by grouping the extracted feature points per divided areas. For example, even though the first feature points extracted from the first image data exist in the second image data as well, the feature point extracting unit may not extract the second feature points from the second image data. Accordingly, the feature point managing unit groups the first feature points so that the second feature points which match any one of the first feature point groups can be traced.

In step 30, the feature point tracing unit of the electronic device 100 traces the feature point groups corresponding to the feature point groups in the second image data by using the feature point groups. The feature point tracing unit compares the first feature point groups of the first image data with the second feature point groups of the second image data per area, to thereby trace feature points of the second feature point groups that match feature points of the first feature point groups.

In step 40, a displacement calculating unit of the electronic device 100 calculates displacement information by using the traced second feature point groups. The displacement calculating unit calculates displacement information by using the change of coordinate values between the first feature point P₁ extracted from the first image data and the second feature point P′₁ traced in the second image data. In an embodiment on the present invention, the displacement calculating unit calculates displacement information by reflecting an acceleration value measured by an acceleration sensor. Alternatively, the displacement calculating unit calculates displacement information by reflecting rotational displacement value measured by a gyro-sensor.

A communication unit of the electronic device 100 transmits the calculated displacement information to external devices. In an embodiment of the present invention, the communication unit controls the external devices by using the displacement information. That is, the communication unit controls the external devices that are paired with the electronic device 100 by using the displacement information.

Although certain embodiments have been described and illustrated in the present specification and drawings, these are provided merely to describe and to facilitate a thorough understanding of the present invention, and are not intended to limit the scope of the present invention. Therefore, it should be construed that all modifications or modified forms drawn by the technical idea of the present invention in addition to the embodiments disclosed herein are included in the scope of the present invention as defined by the appended claims, and their equivalents.

What is claimed is:

1. A method of using an electronic device, the method comprising:
extracting feature points from first image data and second image data, respectively;
grouping the extracted feature points of the first image data and the second image data, respectively;
tracing groupings of extracted feature points of the second image data to corresponding groupings of extracted feature points of the first image data; and
calculating displacement information by using the tracings.

2. The method of claim 1, wherein extracting feature points comprises dividing the first image data or the second image data into at least one area, and extracting the feature points of each at least one area.

3. The method of claim 1, wherein extracting feature points comprises adjusting a threshold value of a feature point extracting algorithm based on a number of extracted feature points.

4. The method of claim 1, wherein extracting feature points comprises:
when the second image data is a blurred image, applying a low-pass filter to the first image data; and
extracting feature points from the first image data applied with the low-pass filter and the second image data, respectively.

5. The method of claim 2, wherein grouping the extracted feature points comprises grouping the extracted feature points by at least one of the divided areas.

6. The method of claim 2, wherein tracing groupings of extracted feature points comprises tracing groupings of extracted feature points by checking whether at least one feature point of the groupings of extracted feature points of the first image data exists in the second image data.

7. The method of claim 1, wherein tracing groupings of the extracted feature points further comprises, when at least one feature point of grouped extracted feature points of the first image data exists in the second image data, selecting the extracted feature point in the second image data, which is the same as the extracted feature point in the first image data by using a distance to a specific feature point in the first image data.

8. The method of claim 1, wherein calculating displacement information comprises calculating displacement information by reflecting an acceleration value measured by an acceleration sensor.

9. The method of claim 1, wherein calculating displacement information comprises calculating displacement information by reflecting a rotational displacement value measured by a gyro-sensor.

10. The method of claim 1, further comprising controlling external devices by transmitting the displacement information to the external devices.

11. An electronic device comprising:
an image input unit;
a feature point extracting unit configured to extract feature points from first image data and second image data received from the image input unit, respectively;
a feature point managing unit configured to group the extracted feature points of the first image data and the second image data, respectively;
a feature point tracing unit configured to trace feature point groups in the second image data to corresponding feature point groups in the first image data; and
a displacement calculating unit configured to calculate displacement information by using the traces.

12. The electronic device of claim 11, wherein the feature point extracting unit is configured to divide the first image data or the second image data into at least one area and extract the feature points per divided areas.

13. The electronic device of claim 12, wherein the feature point extracting unit is configured to adjust a threshold value of a feature point extracting algorithm based on a number of the extracted feature points in the first image data.

14. The electronic device of claim 12, wherein the feature point extracting unit configures an order of priority with respect to at least one of the divided areas and adjusts the threshold value of the feature point extracting algorithm according to the order of priority per area.

15. The electronic device of claim 12, wherein the feature point managing unit is configured to group the extracted feature points by at least one of the divided areas.

16. The electronic device of claim 15, wherein the feature point tracing unit is configured to trace the feature point groups by checking whether at least one feature point of the feature point group in the first image data exists in the second image data.

17. The electronic device of claim 11, wherein the feature point tracing unit, when at least one feature point of the feature point group in the first image data exists in the second image data, is configured to select the feature point in the second image data, which is the same as the feature point in the first image data by using a distance to a feature point in the first image data.

18. The electronic device of claim 11, further comprising an acceleration sensor configured to measure an acceleration value, and wherein the displacement calculating unit calculates the displacement information by reflecting the acceleration value measured by the acceleration sensor.

19. The electronic device of claim 11, further comprising a gyro-sensor configured to measure a rotational displacement value, and wherein the displacement calculating unit is configured to calculate the displacement information by reflecting the rotational displacement value measured by the gyro-sensor.

20. The electronic device of claim 11, further comprising a communication unit configured to transmit the calculated displacement information to the external devices.
